(19) United States
(12) Patent Application Publication
(10) Pub. No.: US 2015/0167784 A1
(43) Pub. Date: Jun. 18, 2015

(54) GEAR, GEAR ASSEMBLY AND APPARATUS HAVING THE SAME

(71) Applicant: Cal-Comp Electronics & Communications Company Limited, New Taipei City (TW)

(72) Inventor: Chih-Hwa Wang, New Taipei City (TW)

(73) Assignee: Cal-Comp Electronics & Communications Company Limited, New Taipei City (TW)

(21) Appl. No.: 14/176,155

(22) Filed: Feb. 10, 2014

(30) Foreign Application Priority Data
Dec. 12, 2013 (TW) 102145926

(51) Int. Cl. F16H 1/06; F16H 55/17

(52) U.S. Cl. CPC F16H 1/06; F16H 55/17

(57) ABSTRACT

A gear, a gear assembly, and an apparatus including the gear assembly are provided. The gear assembly includes two gears, and each of the gears has a ring-shaped body, a gear portion, and a ring-shaped flange. The ring-shaped body has a central axis, and the gear portion and the ring-shaped flange are around the central axis as a center and surround peripheries of the ring-shaped body. The ring-shaped flange is closely adjacent to the gear portion along an axial direction of the central axis. The ring-shaped flanges of the two gears lean against each other, and the gear portions of the two gears are engaged with each other.

### CROSS-REFERENCE TO RELATED APPLICATION

This application claims the priority benefit of Taiwan application serial no. 102145926, filed on Dec. 12, 2013. The entirety of the above-mentioned patent application is hereby incorporated by reference herein and made a part of this specification.

### FIELD OF THE INVENTION

The invention relates to a gear, a gear assembly, and an apparatus. More particularly, the invention relates to a gear, a gear assembly, and an apparatus having the gear assembly.

### DESCRIPTION OF RELATED ART

FIG. 1A schematically shows that two conventional gears are engaged with each other, and FIG. 1B schematically shows that the two gears depicted in FIG. 1A are not engaged with each other. With reference to FIG. 1A and FIG. 1B, the two conventional gears 110 (fixed) and 120 (movable) are relatively positioned and engaged with each other by changing the distance between the axes 112 and 122 respectively in the gears 110 and 120. The gear assembly in a printer is taken as an example: when the printing job is not yet performed, the first gear 110 and the second gear 120 are separated from each other; while the printing job is performed, the first gear 110 and the second gear 120 approach each other and are engaged with each other, so as to achieve power transmission.

Due to the tolerances of manufacturing gears and assembling the gears to other relevant components, the engagement level of the first and second gears 110 and 120 is determined merely by the distance between the axes 112 and 122 respectively in the first and second gears 110 and 120. This may result in poor engagement of the first and second gears 110 and 120 because the teeth of the first and second gears 110 and 120 do not fully come into contact, as shown in FIG. 2A, such that power cannot be effectively transmitted. By contrast, it is also likely for the first and second gears 110 and 120 to be meshed together in an overly tight manner, as shown in FIG. 2B, such that the first and second gears 110 and 120 cannot easily rotate or may be easily worn out during rotation.

FIG. 3 illustrates a conventional way to position another gear. With reference FIG. 3, a gear 130 whose location may vary is set on an outer frame 140, and a corresponding stopper member 152 is set on a housing 150, such that the location of the gear 130 may be controlled by the contact between the outer frame 140 and the stopper member 152. However, the same issue occurring in the gears shown in FIG. 1A and FIG. 1B remains unresolved here, i.e., the gear 130 may not be accurately positioned due to the tolerances of manufacturing and assembling the gear 130, the outer frame 140, or the stopper member 152.

### SUMMARY OF THE INVENTION

The invention is directed to a gear having a ring-shaped flange for performing a positioning function.

The invention is further directed to a gear assembly in which gears have ring-shaped flanges leaning against each other, so as to achieve favorable positioning effects.

The invention is further directed to an apparatus in which gears of a gear assembly may achieve favorable positioning effects, and thus power may be effectively transmitted by means of the gear assembly.

In an embodiment of the invention, a gear that includes a ring-shaped body, a gear portion, and a ring-shaped flange is provided. The ring-shaped body has a central axis, the gear portion and the ring-shaped flange are around the central axis as a center and surround peripheries of the ring-shaped body, and the ring-shaped flange is closely adjacent to the gear portion along an axial direction of the central axis.

According to an embodiment of the invention, an outer diameter of the ring-shaped flange is different from an outer diameter of the ring-shaped body.

In an embodiment of the invention, a gear assembly that includes a first gear and a second gear is provided. The first gear has a first ring-shaped body, a first gear portion, and a first ring-shaped flange. The first ring-shaped body has a first central axis, the first gear portion and the first ring-shaped flange are around the first central axis as a center and surround peripheries of the first ring-shaped body, and the first ring-shaped flange is closely adjacent to the first gear portion along an axial direction of the first central axis. The second gear has a second ring-shaped body, a second gear portion, and a second ring-shaped flange. The second ring-shaped body has a second central axis, the second gear portion and the second ring-shaped flange are around the second central axis as a center and surround peripheries of the second ring-shaped body, and the second ring-shaped flange is closely adjacent to the second gear portion along an axial direction of the second central axis. Here, the first ring-shaped flange and the second ring-shaped flange lean against each other and are engaged with each other.

According to an embodiment of the invention, a distance from the first central axis to the second central axis is a central distance, and a contact ratio of the first gear to the second gear is inversely proportional to the central distance.

According to an embodiment of the invention, the central distance has a constant value if the first ring-shaped flange and the second ring-shaped flange lean against each other.

According to an embodiment of the invention, an outer diameter of the first ring-shaped flange is different from an outer diameter of the second ring-shaped flange.

According to an embodiment of the invention, an outer diameter of the first ring-shaped flange is different from an outer diameter of the first ring-shaped body.

According to an embodiment of the invention, an outer diameter of the second ring-shaped flange is different from an outer diameter of the second ring-shaped body.

According to an embodiment of the invention, the gear assembly further includes a third gear having a third ring-shaped body and a third gear portion. The third ring-shaped body has a third central axis, the third gear portion is around the third central axis as a center and surrounds peripheries of the third ring-shaped body, and the third gear is engaged with one of the first gear and the second gear.

According to an embodiment of the invention, the gear assembly further includes a power transmission shaft connected to one of the first gear and the second gear to provide rotation power.

In an embodiment of the invention, an apparatus that includes a housing and any of the aforesaid gear assemblies is provided, and the gear assembly is configured in the housing.

According to an embodiment of the invention, the housing is a housing of a printer, a housing of a peripheral, a housing of a facsimile machine, or a housing of a scanner.

As discussed above, if the gears equipped with the ring-shaped flanges are applied in the gear assembly, the central distance between the gears may have the constant value when the ring-shaped flanges lean against each other, and the resultant engagement effects are favorable. Said gear assembly may be further applied in an apparatus to ensure satisfactory power transmission and normal operation of the apparatus.

Several exemplary embodiments accompanied with figures are described in detail below to further describe the invention in details.

### BRIEF DESCRIPTION OF THE DRAWINGS

FIG. 1A schematically shows that two conventional gears are engaged with each other.

FIG. 1B schematically shows that the two gears depicted in FIG. 1A are not engaged with each other.

FIG. 2A schematically shows that the two gears depicted in FIG. 1B are insufficiently engaged with each other.

FIG. 2B schematically shows that the two gears depicted in FIG. 1B are engaged with each other in an overly tight manner.

FIG. 3 illustrates a conventional way to position another gear.

FIG. 4 is a schematic view illustrating a gear according to an embodiment of the invention.

FIG. 5 is a schematic view illustrating another gear according to an embodiment of the invention.

FIG. 6 is a schematic view illustrating a gear assembly in which the gears shown in FIG. 4 and FIG. 5 are applied.

FIG. 7A schematically illustrates that the first ring-shaped flange of the first gear and the second ring-shaped flange of the second gear lean against each other.

FIG. 7B is a schematic cross-sectional view along a sectional line A-A depicted in FIG. 7A.

FIG. 7C is a schematic view illustrating the engagement of the first and second gears.

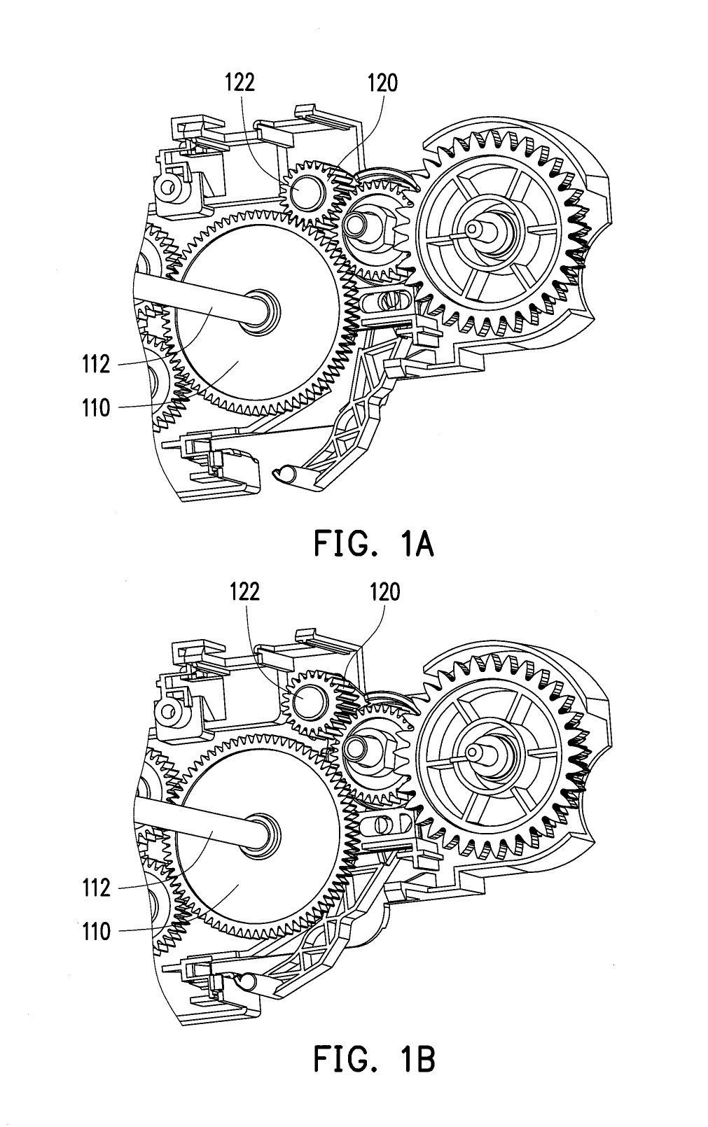

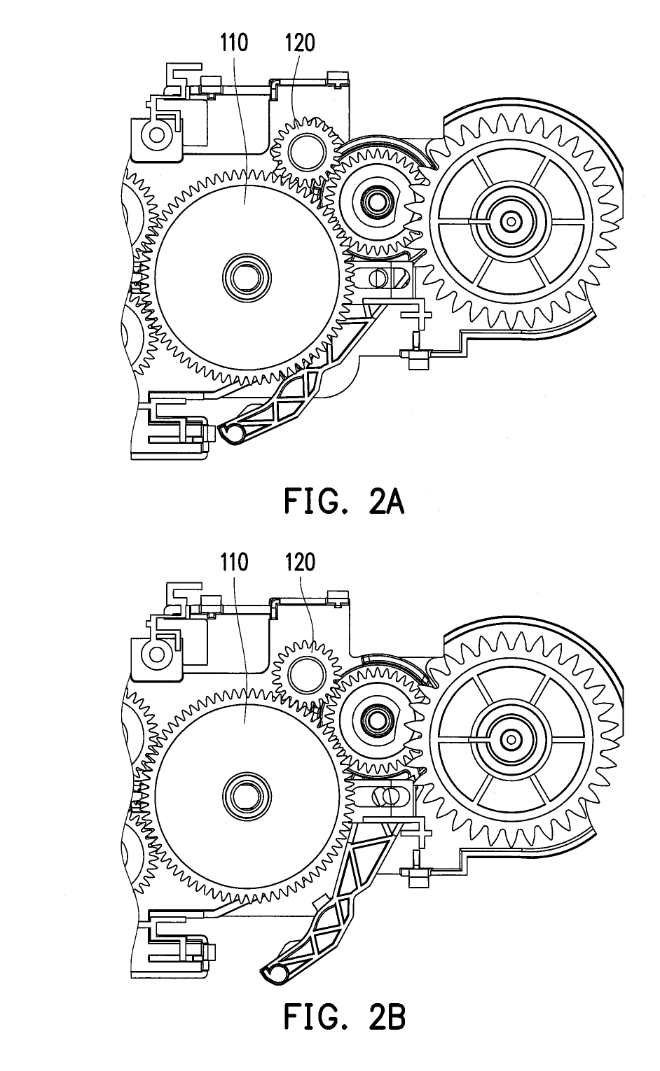

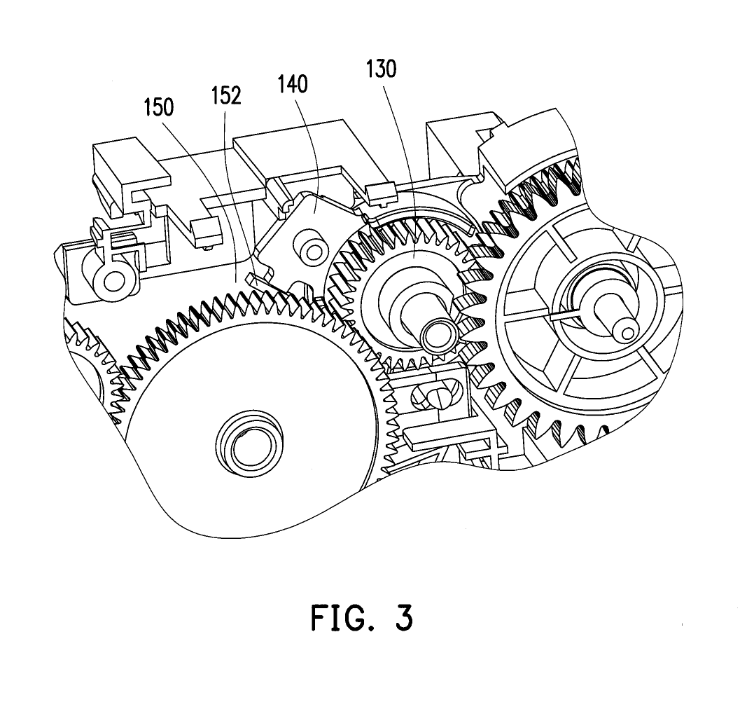

### DETAILED DESCRIPTION OF DISCLOSED EMBODIMENTS

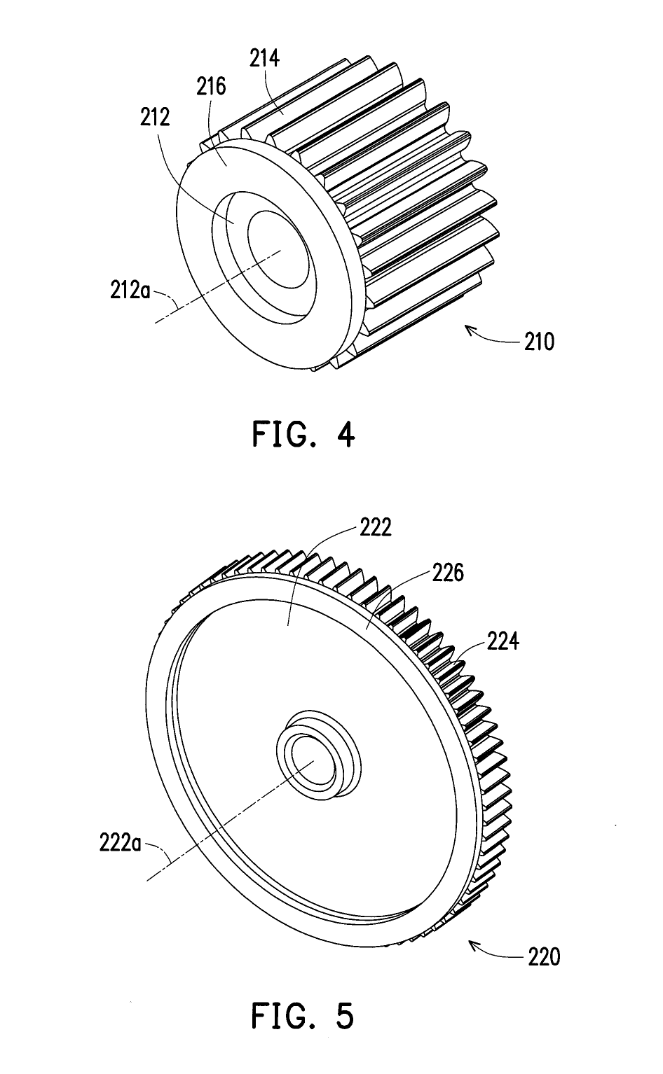

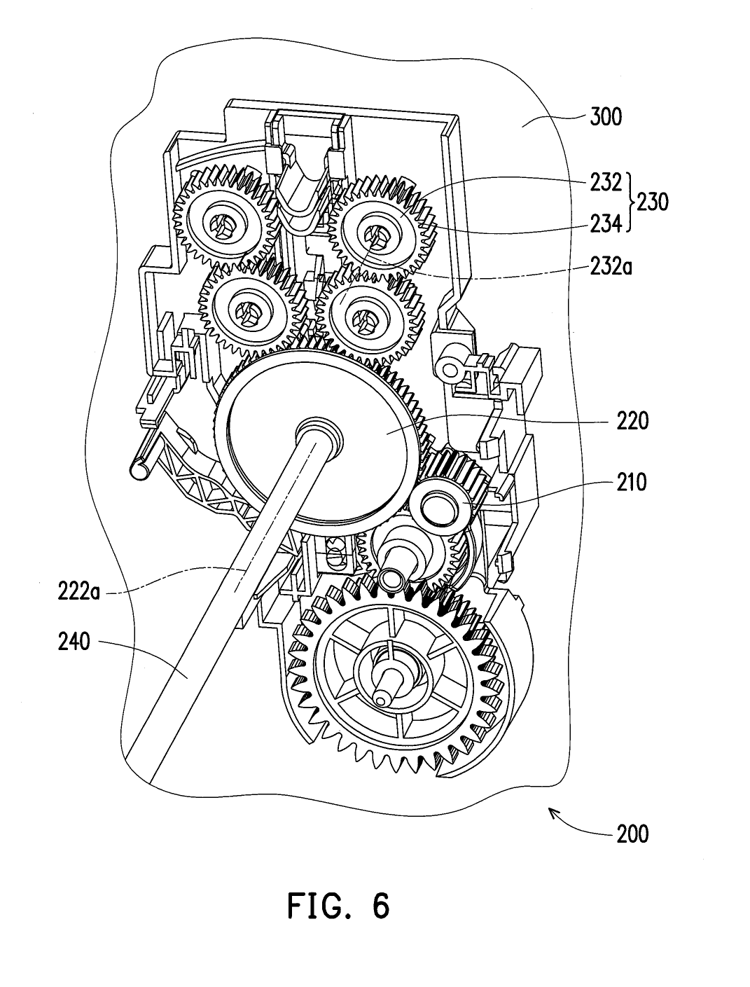

FIG. 4 is a schematic view illustrating a gear according to an embodiment of the invention. FIG. 5 is a schematic view illustrating another gear according to an embodiment of the invention. The structures of the gears respectively shown in FIG. 4 and FIG. 5 are the same; in order to elaborate the invention, the outer diameters of the ring-shaped body of the two gears are designed to be different and thus distinguishable. FIG. 6 is a schematic view illustrating a gear assembly in which the gears shown in FIG. 4 and FIG. 5 are applied, and the gear assembly is configured in a housing 300 of an apparatus. With reference to FIG. 4, FIG. 5, and FIG. 6, the gear assembly 200 includes a first gear 210 and a second gear 220. The first gear 210 has a first ring-shaped body 212, a first gear portion 214, and a first ring-shaped flange 216. The first ring-shaped body 212 has a first central axis 212a, the first gear portion 214 and the first ring-shaped flange 216 are around the first central axis 212a as a center and surround peripheries of the first ring-shaped body 212, and the first ring-shaped flange 216 is closely adjacent to the first gear portion 214 along an axial direction of the first central axis 212a. The second gear 220 has a second ring-shaped body 222, a second gear portion 224, and a second ring-shaped flange 226. The second ring-shaped body 222 has a second central axis 222a, the second gear portion 224 and the second ring-shaped flange 226 are around the second central axis 222a as a center and surround peripheries of the second ring-shaped body 222, and the second ring-shaped flange 226 is closely adjacent to the second gear portion 224 along an axial direction of the second central axis 222a.

A distance from the first central axis 212a to the second central axis 222a is a central distance D1 which poses an impact on a pressure angle between the first gear 210 and the second gear 220. The pressure angle refers to an included angle between the line of action and a tangent of the pitch circle. In brief, the pressure angle is the tilt angle of teeth of the gear, and the gear transmits power along the pressure angle. Hence, if the pressure angle is overly large, the rotational component force exerted on the passive gear by the active gear is lessened, and thereby the efficiency of power transmission is reduced. In addition, a contact ratio of the first gear 210 to the second gear 220 is inversely proportional to the central distance D1. That is, the longer the central distance D1, the smaller the contact ratio.

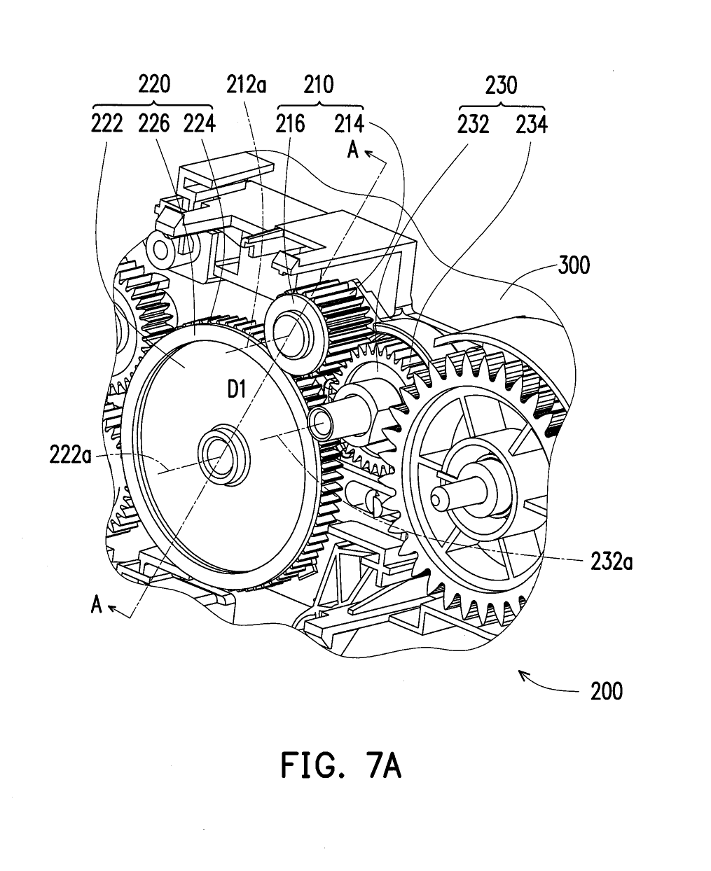

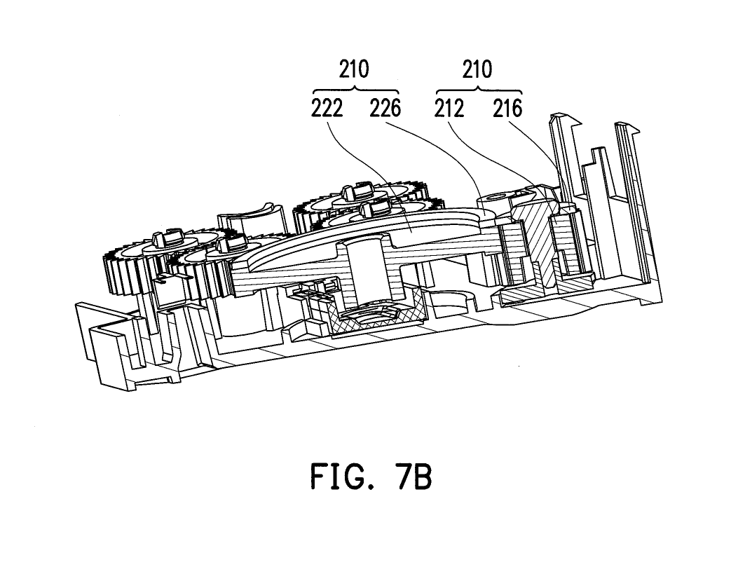

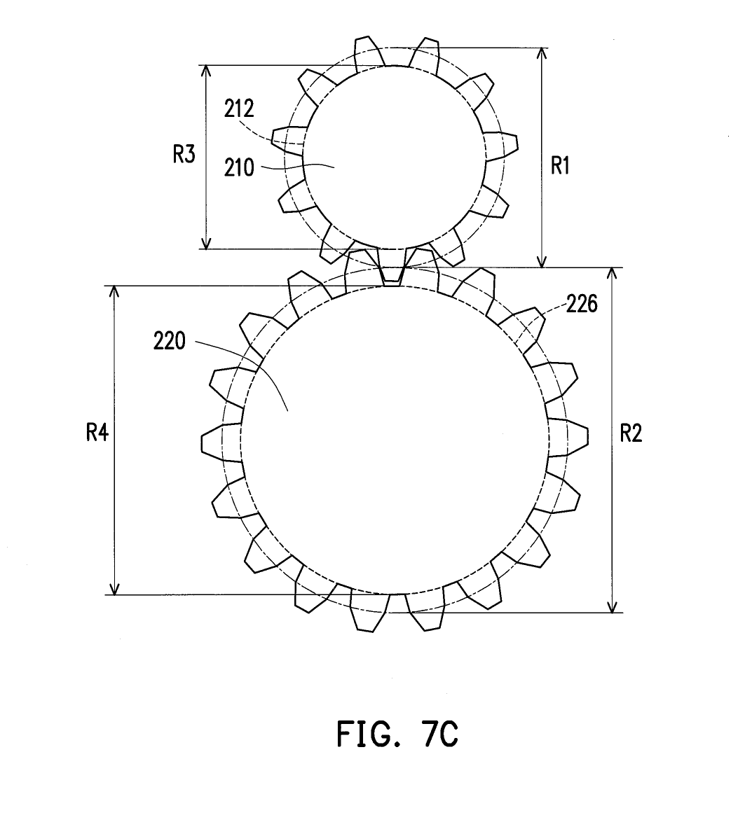

With reference to FIG. 4 to FIG. 6, in response to the different dimensions of the first and second gears 210 and 220, an outer diameter R1 (shown in FIG. 7C) of the first ring-shaped flange 216 is different from an outer diameter R2 (shown in FIG. 7C) of the second ring-shaped flange 226. In the present embodiment, the outer diameter R1 (shown in FIG. 7C) of the first ring-shaped flange 216 is smaller than the outer diameter R2 (shown in FIG. 7C) of the second ring-shaped flange 226. Besides, the outer diameter R1 (shown in FIG. 7C) of the first ring-shaped flange 216 may be different from an outer diameter R3 (shown in FIG. 7C) of the first ring-shaped body 212, and the outer diameter R2 (shown in FIG. 7C) of the second ring-shaped flange 226 may also be different from an outer diameter R4 (shown in FIG. 7C) of the second ring-shaped body 222. The first gear 210 shown in FIG. 4 and the second gear 220 shown in FIG. 5 serve to elaborate the invention. The outer diameter R3 (shown in FIG. 7C) of the first ring-shaped body 212 is the diameter of the dedendum circle of the first gear 210, and the outer diameter R1 (shown in FIG. 7C) of the first ring-shaped flange 216 is greater than the outer diameter R3 (shown in FIG. 7C) of the first ring-shaped body 212 but is smaller than the diameter of the addendum circle of the first gear 210. Similarly, the outer diameter R4 (shown in FIG. 7C) of the second ring-shaped body 222 is the diameter of the dedendum circle of the second gear 220, and the outer diameter R2 (shown in FIG. 7C) of the second ring-shaped flange 226 is greater than the outer diameter R4 (shown in FIG. 7C) of the second ring-shaped body 222 but is smaller than the diameter of the addendum circle of the second gear 220.

With reference to FIG. 6, the gear assembly 200 further includes a third gear 230 having a third ring-shaped body 232 and a third gear portion 234. The third ring-shaped body 232 has a third central axis 232a, the third gear portion 234 is around the third central axis 232a as a center and surrounds peripheries of the third ring-shaped body 232, and the third gear 230 is engaged with one of the first gear 210 and the second gear 220. The axial directions of the first central axis 212a, the second central axis 222a, and the third central axis 232a are in parallel. In FIG. 6, the structure of the third gear 230 is not identical to the structures of the first and second gears 210 and 220, e.g., the third gear 230 is not equipped with the ring-shaped flange. However, in another embodiment of the invention, the third gear 230 may have the same structure as those of the first and second gears 210 and 220 according to actual requirements.

The gear assembly 200 may further include a power transmission shaft 240; in the present embodiment, the power transmission shaft 240 is connected to the second gear 220 to provide the second gear 220 with the rotation power and drive other gears (that are engaged with and moved together with the second gear 220) to move.

FIG. 7A schematically illustrates that the first ring-shaped flange 216 of the first gear and the second ring-shaped flange 226 of the second gear lean against each other. FIG. 7B is a schematic cross-sectional view along a sectional line A-A depicted in FIG. 7A. FIG. 7C is a schematic view illustrating the engagement of the first and second gears. With reference to FIG. 7A, FIG. 7B, and FIG. 7C, when the gear assembly 200 is to be used, the first gear 210 may be arranged opposite to the second gear 220, and the first gear 210 approaches the second gear 220, such that the first ring-shaped flange 216 and the second ring-shaped flange 226 lean against each other. At this time, the teeth of the first and second gears 210 and 220 are meshed together. Hence, when the power transmission shaft 240 rotates, the second gear 220 on the power transmission shaft 240 is driven by the power transmission shaft 240 and is then rotated, and the first gear 210, the third gear 230, and other gears engaged with the second gear 220 are corresponding rotated together with the rotation of the second gear 220, so as to transmit the power obtained through the rotation of the power transmission shaft 240 (shown in FIG. 6).

Since the first ring-shaped flange 216 of the first gear 210 and the second ring-shaped flange 226 of the second gear 220 lean against each other, the central distance D1 from the first gear 210 to the second gear 220 remains constant. In this case, the engagement of the first and second gears 210 and 220 indeed complies with designers' requirements, i.e., the first and second gears 210 and 220 are properly engaged with each other, such that the teeth of the gears 210 and 220 are not stuck, broken, or abraded (because the teeth of the gears are not meshed in an overly tight manner), and that the power is able to be effectively transmitted (because the teeth of the gears are not meshed insufficiently). As a result, the gear assembly 200 can well transmit power.

Since the gears can be accurately positioned, the apparatus (e.g., a printer, a peripheral, a facsimile machine, a scanner, or any other suitable apparatus) in which the gear assembly 200 is applied is able to effectively transmit power. That is, the issue of the insufficient engagement of the gears does not arise here; therefore, the power can be effectively transmitted, and the apparatus can be normally operated. By contrast, the teeth of the gears are not meshed in an overly tight manner, and thus the teeth of the gears are not stuck, broken, or abraded; accordingly, the apparatus having the gear assembly is able to have long service life.

Although the diameter of the ring-shaped flange of each gear exemplified herein is between the diameter of the dedendum circle of the gear and the diameter of the addendum circle of the gear, it should be mentioned that the invention is not limited thereto. As long as two gears are well engaged with each other when the ring-shaped flanges of the two gears lean against each other, the diameter of the ring-shaped flange of each gear may also be shorter than the diameter of the dedendum circle of the gear or longer than the diameter of the addendum circle of the gear.

To sum up, the structure of the gear described herein is different from that of the conventional gear because the gear described herein is equipped with the ring-shaped flange. Hence, the central distance between the gears may have the constant value when the ring-shaped flanges of the gears lean against each other, the resultant engagement effects on the gears are favorable, and power can be effectively transmitted. If the gear assembly is further applied to the apparatus, the apparatus can well function in a normal manner; moreover, the teeth of the gears are not meshed in an overly tight manner, such that the teeth are not stuck, broken, or abraded. As a result, the apparatus having the gear assembly can have long service life.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A gear comprising a ring-shaped body, a gear portion, and a ring-shaped flange, wherein the ring-shaped body has a central axis, the gear portion and the ring-shaped flange are around the central axis as a center and surround peripheries of the ring-shaped body, and the ring-shaped flange is closely adjacent to the gear portion along an axial direction of the central axis.

2. The gear as recited in claim 1, wherein an outer diameter of the ring-shaped flange is different from an outer diameter of the ring-shaped body.

3. A gear assembly comprising:
a first gear comprising a first ring-shaped body, a first gear portion, and a first ring-shaped flange, wherein the first ring-shaped body has a first central axis, the first gear portion and the first ring-shaped flange are around the first central axis as a center and surround peripheries of the first ring-shaped body, and the first ring-shaped flange is closely adjacent to the first gear portion along an axial direction of the first central axis; and
a second gear comprising a second ring-shaped body, a second gear portion, and a second ring-shaped flange, wherein the second ring-shaped body has a second central axis, the second gear portion and the second ring-shaped flange are around the second central axis as a center and surround peripheries of the second ring-shaped body, and the second ring-shaped flange is closely adjacent to the second gear portion along an axial direction of the second central axis,
wherein the first ring-shaped flange and the second ring-shaped flange lean against each other and are engaged with each other.

4. The gear assembly as recited in claim 3, wherein a distance from the first central axis to the second central axis is a central distance, and a contact ratio of the first gear to the second gear is inversely proportional to the central distance.

5. The gear assembly as recited in claim 3, wherein the central distance has a constant value if the first ring-shaped flange and the second ring-shaped flange lean against each other.

6. The gear assembly as recited in claim 3, wherein an outer diameter of the first ring-shaped flange is different from an outer diameter of the second ring-shaped flange.

7. The gear assembly as recited in claim 3, wherein an outer diameter of the first ring-shaped flange is different from an outer diameter of the first ring-shaped body.

8. The gear assembly as recited in claim 3, wherein an outer diameter of the second ring-shaped flange is different from an outer diameter of the second ring-shaped body.

9. The gear assembly as recited in claim 3, further comprising a third gear having a third ring-shaped body and a third gear portion, the third ring-shaped body having a third central axis, the third gear portion being around the third central axis as a center and surrounding peripheries of the third ring-shaped body, the third gear being engaged with one of the first gear and the second gear.

10. The gear assembly as recited in claim 3, further comprising a power transmission shaft connected to one of the first gear and the second gear to provide rotation power.

11. An apparatus comprising:
a housing;
a gear assembly configured in the housing and comprising:
a first gear comprising a first ring-shaped body, a first gear portion, and a first ring-shaped flange, wherein the first ring-shaped body has a first central axis, the first gear portion and the first ring-shaped flange are around the first central axis as a center and surround peripheries of the first ring-shaped body, and the first ring-shaped flange is closely adjacent to the first gear portion along an axial direction of the first central axis; and
a second gear comprising a second ring-shaped body, a second gear portion, and a second ring-shaped flange, wherein the second ring-shaped body has a second central axis, the second gear portion and the second ring-shaped flange are around the second central axis as a center and surround peripheries of the second ring-shaped body, and the second ring-shaped flange is closely adjacent to the second gear portion along an axial direction of the second central axis,
wherein the first ring-shaped flange and the second ring-shaped flange lean against each other and are engaged with each other.

12. The apparatus as recited in claim 11, wherein the central distance has a constant value if the first ring-shaped flange and the second ring-shaped flange lean against each other.

13. The apparatus as recited in claim 11, wherein the gear assembly further comprises a third gear having a third ring-shaped body and a third gear portion, the third ring-shaped body having a third central axis, the third gear portion being around the third central axis as a center and surrounding peripheries of the third ring-shaped body, the third gear being engaged with one of the first gear and the second gear.

14. The apparatus as recited in claim 11, wherein the gear assembly further comprises a power transmission shaft connected to one of the first gear and the second gear to provide rotation power.

15. The apparatus as recited in claim 11, wherein the housing is a housing of a printer, a housing of a peripheral, a housing of a facsimile machine, or a housing of a scanner.
